(19) United States
(12) Patent Application Publication
(10) Pub. No.: US 2015/0081463 A1
(43) Pub. Date: Mar. 19, 2015

(54) SYSTEM AND METHOD FOR FUNDRAISING AND CHARITABLE GIVING AT A POINT OF SALE

(71) Applicant: Renegade Brands, LLC, Beachwood, OH (US)

(72) Inventors: Cathy Horton, Beachwood, OH (US); Dennis Nolan, Beachwood, OH (US); Adam Short, Beachwood, OH (US); Michael Kobyluck, Beachwood, OH (US); George Nanchoff, Beachwood, OH (US); William Beard, Beachwood, OH (US)

(21) Appl. No.: 14/490,611

(22) Filed: Sep. 18, 2014

Related U.S. Application Data
(60) Provisional application No. 61/879,442, filed on Sep. 18, 2013.

(51) Int. Cl. G06Q 30/02; G06Q 20/40; G06Q 20/20

(52) U.S. Cl. CPC G06Q 30/0279; G06Q 20/202; G06Q 20/208; G06Q 20/40
USPC 705/21; 705/44; 705/23; 705/16

(57) ABSTRACT

A system and method for fundraising and charitable giving at a point of sale is disclosed. In one example of a method for fundraising and charitable giving at a point of sale includes the steps of: a customer selecting a product from a store shelf; the customer removing a fundraising tag from the product; the customer completing the information on the fundraising tag, which can include designating an organization to benefit from the fundraising; and a retailer processing the fundraising tag after receiving the completed tag from the customer at the point of sale.

### CROSS-REFERENCE TO RELATED APPLICATION

This application claims priority from U.S. Provisional Patent Application No. 61/879,442 entitled “System and Method for Fundraising and Charitable Giving at a Point of Sale,” filed on Sep. 18, 2013, which is incorporated by reference herein in its entirety.

### FIELD OF INVENTION

The present disclosure relates to systems and methods raising funds for charitable giving at a point of sale. More specifically, the present disclosure relates to systems and methods that associate charitable giving with sale of a product, where the purchaser directs the charitable giving.

### BACKGROUND

Companies offering products for sale in a retail environment strive to leverage retail shelf space in a manner that attracts a customer's or consumer's attention to its products. However, with the abundance of retail shelf space presented to customers and consumers in retail establishments, it can be difficult to distinguish a certain product from its competitors. For any type of product, customers and consumers may be presented with numerous marketing or “shelf talker” materials. Companies are continuously challenged with trying to differentiate their products and brands at the point of sale in order to entice customers and consumers to select their products and increase product turns at shelf. Typical strategies for drawing customer's and consumer's attention to specific products include the use of signs, advertisements, and other marketing materials that describe the product. However, such marketing materials, which are merely informative, may not be sufficient to differentiate a particular product from other products on the shelf and to therefore drive shelf turns.

One strategy for enticing customers and consumers to purchase goods in a retail environment is to associate fundraising or charitable giving with the purchase of goods. Existing fundraising systems often require customers and consumers to mail in rebate forms, mail in proofs of purchase, enter information into a form on a website, or perform other similar administrative tasks after the sale is complete. This may be time consuming and inconvenient for customers and consumers, which limits the number of customers and consumers that take advantage of the charitable giving opportunity. In addition, existing fundraising systems do not enable customers and consumers to select charities the customer and consumer believes are most deserving of benefiting from the fundraising. Typically, fundraising systems offer a limited number of charities that can receive funds. Finally, existing systems may not associate fundraising with purchasing particular products but rather with purchasing items generally from a retailer. Such a system does not enable companies to differentiate their products from other products in the retail store.

### SUMMARY

A system and method for fundraising and charitable giving at a point of sale is disclosed herein. In one example of a method for fundraising and charitable giving at a point of sale includes the steps of: a customer selecting a product from a store shelf; the customer removing a fundraising tag from the product; the customer completing the information on the fundraising tag, which can include designating an organization to benefit from the fundraising; and a retailer processing the fundraising tag after receiving the completed tag from the customer at the point of sale.

### BRIEF DESCRIPTION OF THE DRAWINGS

In the accompanying drawings, structures are illustrated that, together with the detailed description provided below, describe example embodiments of the claimed invention. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 illustrates an example system for fundraising at a point of sale.

FIG. 2 is an example fundraising tag associated with an example product.

FIG. 3 is a view of the back of the example fundraising tag of FIG. 2.

FIG. 4 illustrates another example system for fundraising at a point of sale.

FIG. 5 illustrates another example system for fundraising at a point of sale.

FIG. 6 illustrates another example system for fundraising at a point of sale.

FIG. 7 is a flow chart illustrating an example method for fundraising at a point of sale.

FIG. 8 is a block diagram of an example computing system for implementing an example system for fundraising at a point of sale.

### DETAILED DESCRIPTION

This disclosure includes a number of definitions that are identified at the end of this detailed description. For this disclosure, the terms “computing device,” “computer readable media,” “logic,” “software,” and “user” will include the definitions hereinafter provided in this detailed description.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

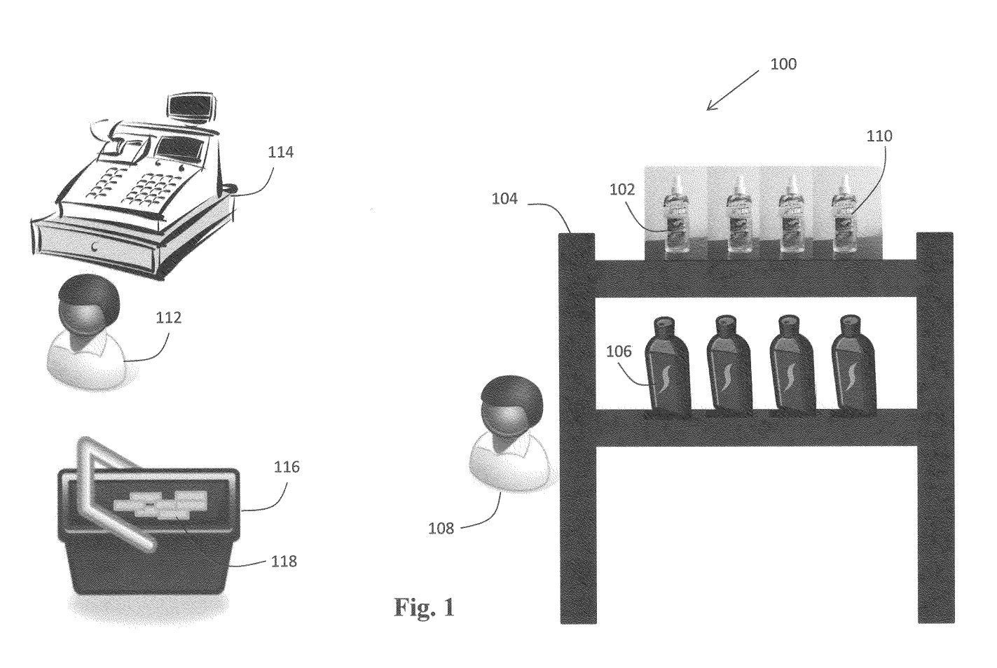

FIG. 1 illustrates an exemplary embodiment of a system 100 for fundraising at a point of sale. As used herein, the term “fundraising” can include donations, gifts, aid, assistance, contributions or any other suitable form charitable giving. As used herein, the phrase “fundraising at the point of sale” means that a customer can direct charitable giving, either by the retailer, the manufacture, or any other entity, to a charity or organization of the customer's choice.

The system 100 enables a manufacturer to distinguish a manufacturer's product 102 (hereinafter referred to as “the product”) on a store shelf 104 from another product 106 on the store shelf 104 by offering a customer 108 the opportunity to fundraise at the point of sale when customer 108 purchases the product 102.

As used herein, the term “customer” refers to a customer, consumer, or any other individual or organization that purchases or considers purchasing a good or service from a provider of goods or services. For example, a customer can be an individual that visits a retail establishment and purchases an item displayed on the retail establishment's shelves. In another example, a customer can be an individual that purchases an item offered for sale on a website's “virtual” shelves. It will be understood that the term “manufacturer” is used for convenience only and can include resellers, wholesalers, distributors, consignors, or other suitable party within a supply chain that wishes to offer a customer an opportunity to purchase a good or service and perform charitable giving at a point of sale. It should be understood that, although the examples illustrated are directed to “brick-and-mortar” store shelves, the example systems and methods may similarly be implemented in a virtual or online store to enable a customer to perform charitable giving when making an online purchase.

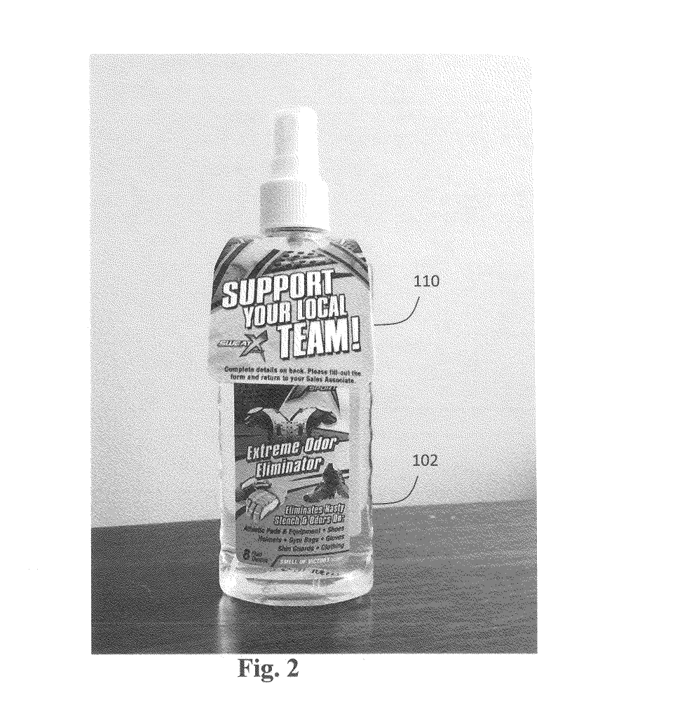

In order to facilitate fundraising at the point of sale and to distinguish the product 102 from another product 106, the product 102 can be combined with a fundraising tag 110. FIG. 2 is a detailed view of an example product 102 including an associated fundraising tag 110. It should be understood that, although the example illustrates the product to be an odor eliminator sold in a retail store, the systems and methods described herein can be used to fundraise with any suitable product. For example, fundraising can be facilitated by the sale of any type of product sold in a retail store or through any other sales channel, including online or virtual stores, or any other suitable channel for selling products to customers. In another example, fundraising can be facilitated by the sale of services offered by a store or any other service provider. It should also be understood that, although the example illustrates the fundraising tag 110 positioned over the top of the product 102 wherein a portion of the product 102 protrudes through an opening in fundraising tag 110, the product 102 can be associated with fundraising tag 110 in any suitable manner. For example, fundraising tag 110 can be secured to the product using an adhesive, a rubber band, a staple, and so on.

Fundraising tag 110 includes text, graphics, or any suitable combination of text and graphics for conveying a fundraising message to a customer 108. For example, fundraising tag 110 can include text that informs customer 108 that a portion of the proceeds from sale of the product 102 can be directed to an organization of customer's 108 choice upon customer's 108 purchase of the product 102.

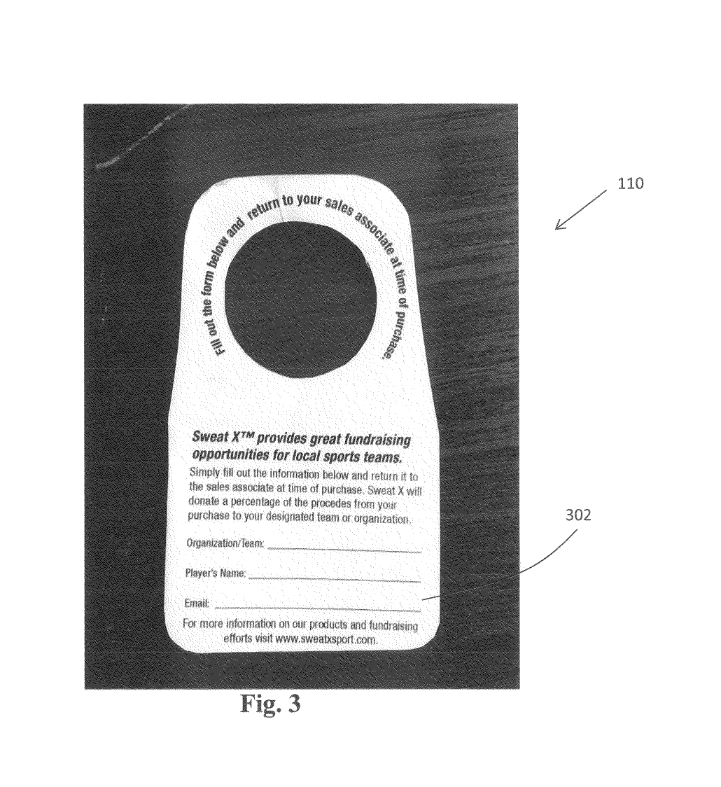

Fundraising tag 110 can further include text, on the front, that informs customer 108 to complete details regarding the customer's choice of charitable organizations on the back of the fundraising tag 110, in order to direct a portion of the proceeds from the sale to a specific organization. FIG. 3 is a view of the back of an example fundraising tag 110. The back of fundraising tag 110 can include a data entry space 302 where a customer 108 can provide suitable information such as customer's 108 name and contact information as well as a name of an organization that the customer 108 would like to designate as a beneficiary of the fundraising. The back of fundraising tag 110 can also include instructions for how to complete a fundraising process. For example, the text on the back of the fundraising tag 110 can instruct customer 108 to fill out the back and to return the fundraising tag 110 to a sales associate at the retail store at the time of purchase.

Referring again to FIG. 1, a store associate 112 operating a point-of-sale 114 system is trained to receive the fundraising tag 110 from customer 108 after customer 108 purchases the product 102. The store associate 112 is also trained to place the fundraising tag 110 into a collection bin 116 for later processing (the group of collected fundraising tags are referred to herein as reference number 118). The store associate 112, a store manager (not shown), or any suitable person can be trained to process the collected fundraising tags 118. In one example, processing collected fundraising tags 118 can include sending them to the manufacturer, distributor, or other source of the products. The manufacturer can then distribute raised funds to the respective organizations as indicated by the information filled out on the collected fundraising tags 118.

In another example, processing collected fundraising tags 118 can include the retailer distributing raised funds to the respective organizations and then requesting reimbursement from the manufacture. In another example, the retailer can process the collected fundraising tags 118 and distribute raised funds to the respective organizations, where the charitable portion is already included in the retail cost of the product. In such example, system 100 enables customer 108 to complete the fundraising at the point of sale without the need for further action after leaving the retail store.

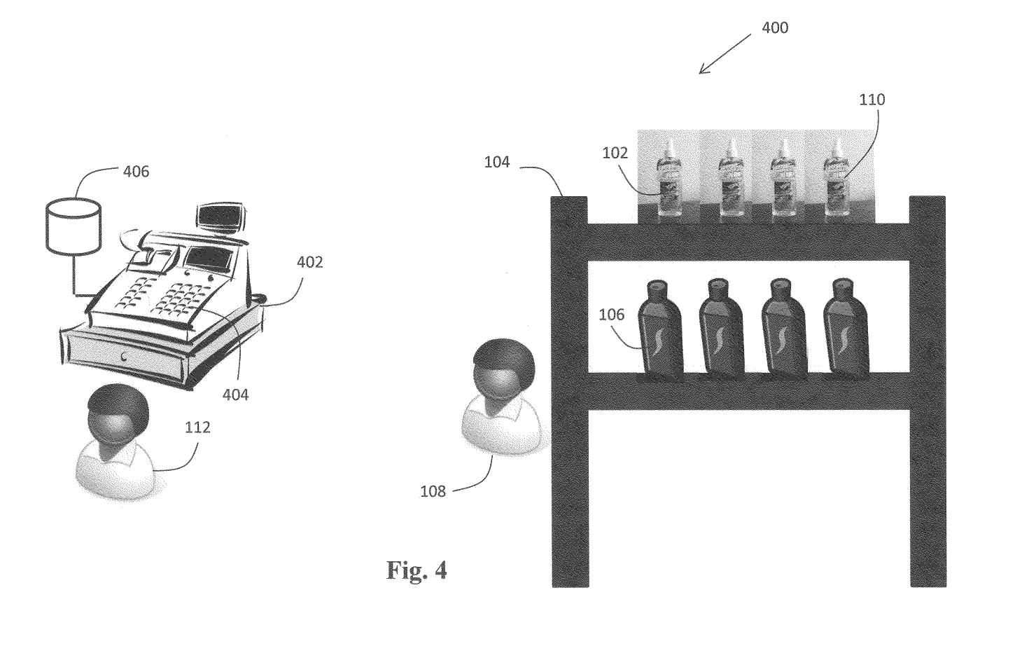

In one example, a sales associate reads information from the back of a fundraising tag 110 and enters the information directly into a point of sale system. As illustrated in FIG. 4, in a system 400 for fundraising at a point of sale, a store associate 112 operating a point-of-sale 402 system is trained to receive the fundraising tag 110 from customer 108 after customer 108 purchases the product 102. Rather than collecting the fundraising tag 110 into a collection bin for later processing as described in FIG. 1, the store associate 112 can be trained to input information read from the back of the fundraising tag 110 into point of sale system 402 via a user interface 404. Point of sale system 402 is configured to store the fundraising information provided by the store associate 112 in a fundraising database 406.

The store associate 112, a store manager (not shown), or any suitable person can be trained to later process the fundraising data stored in the fundraising database 406. In one example, processing stored fundraising data can include communicating the data to the manufacturer. The manufacturer can then distribute raised funds to the respective organizations as indicated by the information in the received data. In another example, processing stored fundraising data can include the retailer distributing raised funds to the respective organizations, where the distributed funds are either already accounted for in the price of the product or the retailer can request reimbursement from the manufacture. In one example, a manufacturer and a retailer can share the cost associated with distributing the funds based on any business agreement reached by the manufacturer and retailer.

System 400 can be arranged so that the system 400 can enable customer 108 to complete the fundraising at the point of sale without the assistance of a store associate or other store employee or the need for further action after leaving the retail store. For example, a monitor or credit card reader used by the customer can be arranged so that the monitor or credit card reader displays options to the consumer and the customer can directly enter information regarding the customer's choice of charity or other organization. The customers choices are handled by the system 400 without the need for an employee to handle information or data.

In one example, a customer may not be required to fill out any information at the point of sale. Rather, raised funds can be distributed based on a customers predefined preferences for fundraising. For example, a customer can preregister with a fundraising program through a retailer's website, mobile application or a third-party hosted online portal, website, or mobile application by providing a name, email address, or other suitable account information as well as at least one preferred organization for receiving funds raised. Registration can be performed from any computing device including a laptop computer, a desktop computer, a mobile phone, a store kiosk, and so on. A customer can register for a the fundraising program before arriving at the retail store or at the retail store using a mobile phone or an in-store kiosk for example. In addition, a customer can register for the fundraising program during an visit to a retail store, for example, during a previous point of sale transaction. Once registered, customer information, including fundraising preferences, can be stored by the retailer for use with subsequent customer point of sale transactions.

Registering for the fundraising program can include specifying a single organization for receiving all raised funds. Alternatively, registering can include selecting more than one organization for receiving raised funds. In such an example, a customer can predefine the organizations that benefit from particular purchases. For example, a customer can specify that all purchases made at a first store should benefit a first organization while all purchased made at a second store should benefit a second organization. Alternatively, a customer can define how raised funds are distributed based on product categories, geographic location of purchase, amount of purchase, or by any other suitable categorization of a purchase. In another alternative, the customer can specify that the funds are distributed to charities chosen on a rotating basis.

In such an example, a fundraising tag may not include space on the back for entering information manually by a customer. Rather, the fundraising tag can include a barcode, an RFID tag or other computer readable source of information that identifies the product as one which should be processed for fundraising. In another example, a fundraising tag can include both space on back for entering information manually by a customer and a barcode, RFID tag or other computer readable source of information.

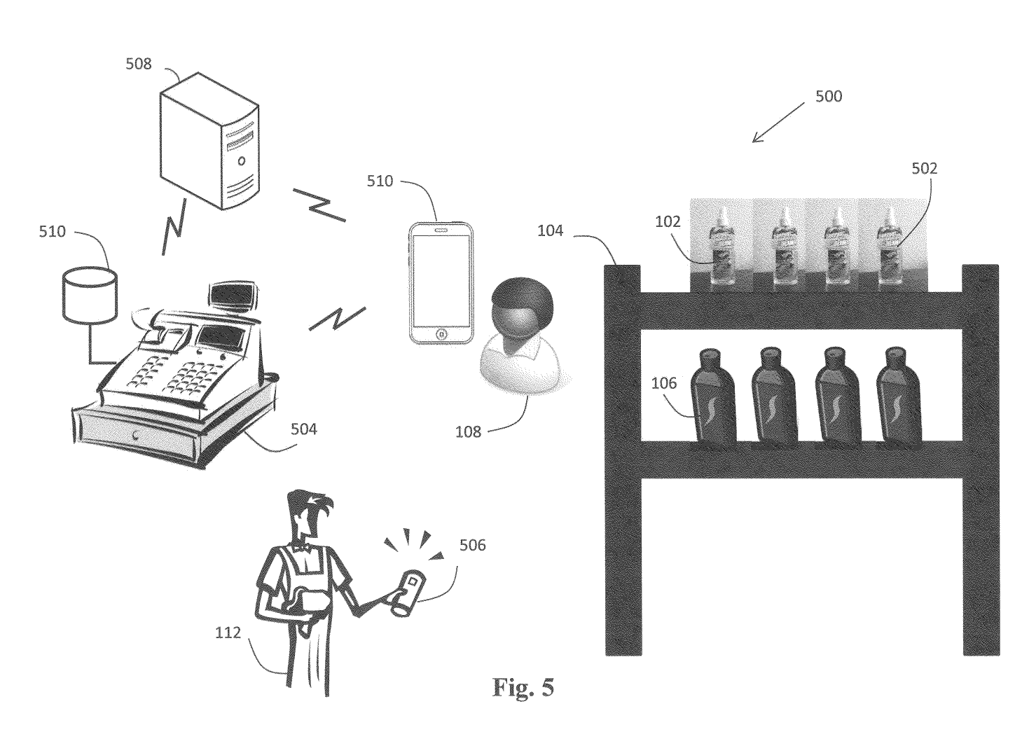

FIG. 5 illustrates such an example system 500 for fundraising at a point of sale. A store associate 112 operating a point-of-sale 504 system is trained to receive the fundraising tag 502 from customer 108 after customer 108 purchases the product 102. Rather than manually enter fundraising information into point of sale system 402 as described in FIG. 4, the store associate 112 is trained to scan a barcode, for example, of a fundraising tag 502 using a point of sale scanner 506. The scanning of the barcode of the fundraising tag 502 indicates to point of sale system 504 that a portion of the proceeds from the sale of the product 102 should be directed to a selected organization.

In order to determine a selected organization for receiving the raised funds associated with the sale of the product 102, point of sale system 504 can be configured to receive information about the identity of the customer 108 and to communicate with a fundraising server 508 to retrieve the identified customer's 108 predefined preferences for fundraising. A sales associate 112 can identify a customer 108 by asking the customer for an email address or for other suitable identifying information and by manually entering the identifying information into point of sale system 504.

Alternatively, a customer 108 can identify himself to point of sale system 504 by presenting an electronically readable apparatus such as shopper card or credit card that includes a chip or magnetic strip electronically readable by the point of sale system 504. In another example, a computing device such as a smartphone or other portable appliance can include electronically readable information that can identify the customer 108 to the point of sale system 504. In one example, the customer shopper card can be presented to the sales associate 112 to be scanned by point of sale scanner 506. In another example, a barcode can be presented to be scanned using an application on a mobile phone 510. In another alternative, if the customer 108 is paying with a credit card, the point of sale system 504 can be arranged to identify the customer 108 by the customer's 108 credit card information.

Point of sale system 504 can be further configured to store, in a fundraising database 510, customer identification information as well as the preferred organization to benefit from the fundraising, in association with the sale of a specific product. This collected and stored information can be saved for later processing by the retail store. In another example, the collected information can be communicated to a manufacturer for processing.

In another example, point of sale system 504 may not store information in a fundraising database 510. Instead, point of sale system 504 can be configured to communicate, to fundraising server 508, information about the identified customer 108 as well as information about the product 102 being purchased. In this example, fundraising server 508 is configured to identify the identified customer's 108 preferred organization for receiving the benefit of the fundraising based on information received about the product 102 being purchased and based on predefined preferences specified by the customer 108.

Fundraising server 508 can be configured to process fundraising transactions by distributing funds to the associated organizations and then requesting reimbursement from respective manufacturers. Alternatively, fundraising server 508 can be configured to communicate the fundraising transactions to the respective manufacturers for payment processing.

In one example, a fundraising tag may not be required. Rather, a point of sale system 504 can be configured to determine that a product is associated with a fundraising program based on scanning the barcode, RFID tag, or other source of information associated with the product. In such an example, a sign, advertisement, or some other indicia can be placed near the product shelf to inform the customer 108 that a particular product is associated with a fundraising program.

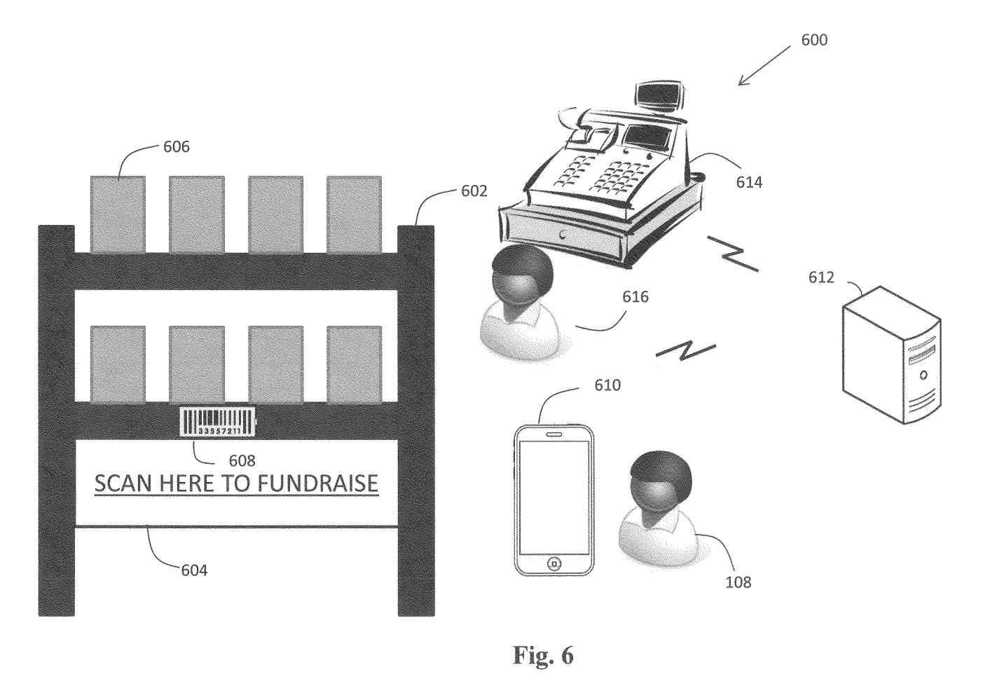

In one example, the steps to initiate the fundraising can be performed by a customer at the store shelving unit. A point of sale system's role in such an example is to confirm purchase of a product in order for the fundraising to be processed. FIG. 6 illustrates another example system 600 for fundraising at a point of sale. A store shelf 602 includes a shelf sign 604 or other similar marketing material or indicia to indicate to a customer 108 that a particular product 606 is associated with a fundraising program. The store shelf 602 also includes a bar code 608 positioned near the display of the product 606. The shelf sign 604 indicates to the customer 108 that scanning the bar code 608 is required to initiate the fundraising process. In such an example, it is not necessary to attach a fundraising tag to each product.

A customer 108 scans the barcode with a mobile phone 610 to initiate the fundraising process. By scanning the barcode 608 on the store shelf 602, the customer 108 is indicating intent to purchase the product and a desire to direct a portion of the proceeds of the sale of the product to a preselected organization. This information, along with the customer's identification is transferred to a fundraising server 612 for processing as described for FIG. 5. Alternatively, the shelving unit can include a barcode reader that the customer 108 uses to scan the product to indicate the customer's intent to purchase the product.

However, before fundraising server 612 can proceed with processing the distribution of proceeds to selected organizations, fundraising server 612 can first receive confirmation that the customer 108 has completed the purchase of the product 606. This prevents fundraising from occurring in the event that a customer 108 changes his mind and decides not to purchase a product 606 after the customer 108 picked up the product from the store shelf 602 and scanned the bar code 608 with a mobile phone 610 or a barcode reader.

To confirm the purchase of a product 606 in order to initiate the fundraising process, a store associate 616 can be trained to receive a customer's 108 identification information, such as a name, email address, phone number, or other suitable information for identifying the customer 108, and to enter the information into a point of sale system 614. Similarly, the store associate 616 can be trained to receive a customer's 108 identification information by using a point of sale scanner to scan the customer's shopper card. The point of sale system 614 is configured to communicate the customer's 108 identification information along with information about which fundraising-eligible products the customer 108 purchased to the fundraising server 612. Fundraising server 612 is configured to cross-reference the actual purchases that customer 108 made with the barcodes that the customer 108 scanned with the mobile phone 610 or with the barcode reader. After the fundraising server 612 confirms that the products associated with the scanned barcodes were purchased, fundraising server 612 is configured to process the distribution of proceeds to selected organizations.

In another example, user 108 can be required to confirm the purchase of products by scanning or taking a photo of a store receipt with a mobile phone 610 and communicating the scanned receipt to the fundraising server 612.

In another example, a product 606 can include an RFID tag. In such an example, system 600 can include an RFID scanner (not shown) for automatically detecting when a product 606 is being paid for and/or when the product is leaving the store. The RFID scanner can be positioned near the point of sale system 614, near an exit, or in any suitable location for detecting that a customer 108 is leaving the store with the product 606. The RFID scanner is further configured to communicate with the fundraising server 612 and to confirm that the customer 108 purchased the product so that fundraising server 612 can proceed with processing the distribution of proceeds to selected organizations.

As previously noted, although the examples provided above are directed generally to brick-and-mortar stores with physical and fixed shelves, the methods and systems described herein are also applicable to virtual stores that utilize websites, mobile applications, and other such applications to offer goods and services for sale to online customers. It will be understood that the presentation of goods or services to online customers on a website or mobile application includes providing virtual shelf space to such goods and services. For example, a website can display a number of competing products on a page to offer an online customer purchasing options. It will be understood that when an online customer selects a particular product for purchase, such a selection is the point of sale for the product. Thus, associating one of the products presented to a customer on the virtual shelf with the opportunity to fundraise at the point of sale can make the product more attractive to the online customer and make the sale of that product more likely as compared to its competing products. At the point of sale, the online customer can be asked for information regarding preferred organizations for receiving the charitable contribution. The online consumer can be asked to manually select preferences by entering text, selecting from drop down menus, radio buttons, and so on. A database of online consumers and preferences can be created by storing an online consumer's previous selections or by having the online consumer manually enter global preferences. The online consumer can be identified by name, email address, login credentials, or any other electronic indicia of the online consumer's identity.

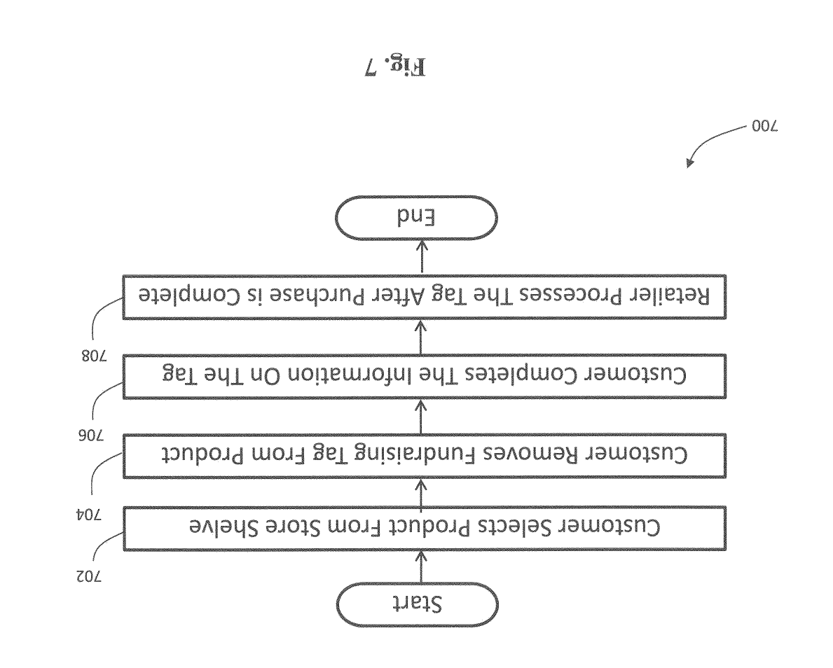

FIG. 7 is a flow chart illustrating an example method for fundraising at a point of sale. At step 702, a customer identifies a product on a store shelf as being associated with fundraising and selects the product from the store shelf. At step 704, the customer removes the fundraising tag from the product. At step 706, the customer completes the information on the fundraising tag by providing personal identification information and designating an organization to benefit from the fundraising. At step 708, the retailer processes the fundraising tag after receiving the completed fundraising tag from the customer at the point of sale.

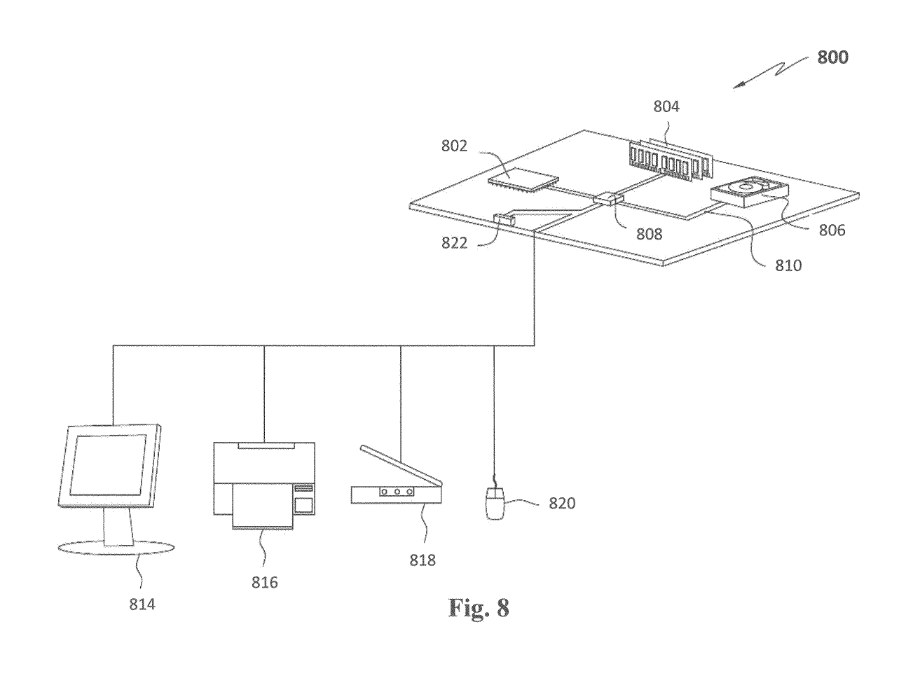

FIG. 8 is a block diagram of an example computing system 800 for implementing an example system for fundraising at a point of sale. The example computing system 800 is intended to represent various forms of digital computers, including laptops, desktops, handheld computers, smartphones, tablet computers, servers, and other similar types of computing devices. As shown, computing system 800 includes a processor 802, memory 804, a storage device 806, and a communication port 822, operably connected by an interface 808 via a bus 810.

Processor 802 processes instructions, via memory 804, for execution within computing system 800. In an example embodiment, multiple processors along with multiple memories may be used.

Memory 804 may be volatile memory or non-volatile memory. Memory 804 may be a computer-readable medium, such as a magnetic disk or optical disk. Storage device 806 may be a computer-readable medium, such as floppy disk devices, a hard disk device, optical disk device, a tape device, a flash memory, phase change memory, or other similar solid state memory device, or an array of devices, including devices in a storage area network of other configurations. A computer program product can be tangibly embodied in a computer readable medium such as memory 804 or storage device 606.

Computing system 800 may be coupled to one or more input and output devices such as a display 814, a printer 816, a scanner 818, and a mouse 820.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the invention is to be determined by the appended claims and their equivalents.

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computing device,” as used herein, refers to a laptop computer, a desktop computer, a smartphone, a personal digital assistant, a cellular telephone, a tablet computer, an eReader, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners. One form of software is an app, or an application that executes on a mobile computing device such as a mobile phone.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

1. A method for fundraising and charitable giving, the method comprising the steps of:
displaying products for purchase on a store shelf;
receiving an indication from a customer that the customer agrees to make a charitable contribution in connection with a purchase of the product;
receiving documented information from the customer, including a designation of at least one organization to benefit from the charitable contribution; and
processing the documented information to direct the charitable contribution to the at least one designated organization.

2. The method of claim 1, where the documented information is received from a fundraising tag associated with the product and completed by the customer; and
the documented information is processed at a point of sale.

3. The method of claim 2, wherein a sales associate of a retailer processes the fundraising tag to receive the documented information.

4. The method of claim 1, where a retailer receives the documented information electronically at a point of sale.

5. The method of claim 4, where the documented information is received from a database that associates the documented information with the customer.

6. The method of claim 5, where the database associates the documented information with electronic indicia of the consumer's identity.

7. The method of claim 5, where the documented information is received from the customer via the Internet.

8. The method of claim 4, where the documented information is received from an electronically readable apparatus.

9. The method of claim 8, where the electronically readable apparatus is a card with an electronically readable chip or magnetic strip.

10. The method of claim 8, where the electronically readable apparatus is a computing device.

11. The method of claim 1, where the documented information is received at the store shelf.

12. The method of claim 11, where the documented information is received at the store shelf by an scanner.

13. The method of claim 1, where the organization benefiting from the charitable contribution is determined by the type of product purchased, geographic location of the purchase, or amount of purchase.

14. A method for fundraising and charitable giving at a virtual point of sale, the method comprising the steps of:
presenting goods and services for purchase to online customers;
associating at least one of the products or services presented for purchase with an opportunity for the online consumer to make a charitable contribution upon the purchase of said at least one of the products or services presented for purchase;
receiving information from the online consumer, including a designation of at least one organization to benefit from the charitable contribution; and
processing the received information to direct the charitable contribution to the at least one organization to benefit from the charitable contribution.

15. The method of claim 14, where the information is received from the online consumer upon a purchase of the one or more product or service.

16. The method of claim 15, where the online consumer is requested to manually provide the information.

17. The method of claim 14, where the information is received from a database that associates the information with the online customer.

18. The method of claim 17, where the database is populated by past information received from online customers.

19. The method of claim 17, where the online consumer is identified by electronic indicia of the online consumer's identity.

20. The method of claim 19, where the electric indicia is an email address.
